(19) United States
(12) Patent Application Publication
(10) Pub. No.: US 2018/0300856 A1
(43) Pub. Date: Oct. 18, 2018

(54) SYSTEM ADAPTED FOR PROVIDING AN OPERATOR WITH AUGMENTED VISIBILITY AND ASSOCIATED METHOD

(71) Applicant: THALES, Courbevoie (FR)

(72) Inventors: Etienne PAYOT, Elancourt Cedex (FR); Jérôme ARTAUD, Elancourt Cedex (FR)

(73) Assignee: THALES, Courbevoie (FR)

(21) Appl. No.: 15/768,350

(22) PCT Filed: Oct. 21, 2016
(86) PCT No.: PCT/EP2016/075412

§ 371 Date: Apr. 13, 2018

(30) Foreign Application Priority Data
Oct. 22, 2015 (FR) 15 02237

(51) Int. Cl. G06T 3/40; G02B 27/01

(52) U.S. Cl. CPC G06T 3/4061; G02B 27/0172; G06T 2207/20024; G02B 2027/0187; G02B 2027/0147

(57) ABSTRACT

The invention relates to a system suitable for providing an operator with enhanced visibility, useful in particular to aid aircraft piloting, comprising at least one sensor able to capture image data in a given spectral band and a central calculation unit able to process the image data captured and to transmit them to a display unit. This system comprises:
at least one high-resolution sensor (20) able to acquire image data forming a digital image (I₀) in a spectral band including at least all or some of the spectral band visible to the human eye, of first spatial resolution, and of strictly finer angular capture resolution than the angular resolution of the human eye, and
a nonlinear processing module (22) adapted to produce a change in spatial resolution while preserving bright points of said digital image acquired (I₀) so as to obtain a digital image (I₁) to be displayed of second spatial resolution lower than the first spatial resolution.

The present invention relates to a system adapted for providing an operator with augmented visibility, in particular used to aid aircraft piloting, and an associated method.

The invention falls within the field of enhanced vision systems (EVS), which are imaging systems intended to provide an operator with an image of the environment that is improved relative to human perception, this image being able to be presented using a “head-up display” (HUD) or a viewing monitor (so-called “head-down” display).

These EVS systems are particularly applicable in the field of aiding aircraft piloting, in particular during the approach and landing phases, but also during taxi and takeoff, in case of low visibility due to poor environmental and/or weather conditions.

Indeed, in the aeronautic field, it is typical to mark airport takeoff/landing strips using markers, in particular illuminated beacons, for example the approach ramp, and the illuminated edge and runway center beacons.

In order to guarantee safety in the air transport field, regulations exist imposing a given runway visual range to engage a landing approach, for example. The runway visual range (RVR) is defined as the distance up to which an aircraft pilot, placed in the axis of the runway, can see, using his natural vision, the marks or lights defining the runway or serving as beacons for the axis thereof. The RVR is generally evaluated by an automatic calculation integrating the instrumental measurements relative to the transmission coefficient of the atmosphere and the background light and information on the intensity of the illuminated beacons. For example, for a so-called CAT 1 (Category 1) approach, the regulation requires a minimum RVR value of 550 meters to initiate an approach, other requirements also existing, and the regulation makes it possible to descend to a decision height (DH) equal to at least 200 ft (200 feet), at which height the pilot must discern the visual references to go below the decision height DH. Such a visual range is difficult to obtain under certain poor weather conditions, which may make the illuminated beacons non-discernible by the pilot at the decision height DH.

EVS systems have been designed, in particular to resolve this problem and improve the natural vision of piloting crews, and to extend the landing capacities in poor visibility conditions. The regulations in particular make it possible, in the example cited above, to go below 100 ft if the necessary visual references have been able to be discerned by the pilot at 200 ft using an EVS and even if they are not discernible by the human eye.

At this time, EVS systems are known including image sensors in the infrared spectral band using the spectral bands from 3 to 5 μm or from 8 to 14 μm and in the shortwave infrared (SWIR) spectral band for electromagnetic signals with a wavelength extending from 1 μm to 2.5 μm. The use of sensors in the SWIR spectral band is intended to optimize the capacities for detecting incandescent bulbs commonly used to mark the runways.

However, the recent illuminated beacons use new lighting techniques with light-emitting diodes (LED), which do not emit beyond a wavelength of 1 μm.

Patent application WO 2009/128065 A1 describes an EVS system comprising a plurality of sensors able to operate in various spectral bands, comprising the NIR (Near Infra-Red) spectral band for electromagnetic signals with a wavelength extending from 0.7 μm to 1.0 μm, and the spectral band of the visible light, which extends from 0.4 μm to 0.7 μm. This system merges image data acquired by the various sensors. The spectral bands to be merged are selected based on weather conditions identified beforehand and the nature of the illuminated beacons to be detected.

However, aside from its calculation complexity and its high manufacturing cost, such a system has a performance limited to the performance of the best of the spectral bands present in the equipment. Furthermore, it is not possible to predict the performance of the system, i.e., the visibility gain relative to the human eye, because this gain varies based on weather and atmospheric conditions, background luminance and the intensity of the illuminated beacons. Consequently, it is not easy, with such a system, to predict whether, for a given RVR value, the system will make it possible to achieve the required performance levels to initiate and eventually perform the landing.

Below, we define the angular resolution as the elementary field of view of a pixel of an image sensor detector. The angular resolution of the human eye is generally considered to be about 0.8 minutes of arc, or 0.0135° (or 0.00029 radians). Likewise, below, a high spatial resolution will designate a fine angular resolution, therefore a small angle of resolution/elementary field of view.

The invention aims to resolve the aforementioned drawbacks of the state of the art.

To that end, according to a first aspect, the invention proposes a system suitable for providing an operator with enhanced visibility, intended to aid the piloting of an aircraft, comprising at least one sensor able to capture image data in a given spectral band and a central calculation unit able to process the captured image data and to transmit the processed image data for display of a digital image on a display unit.

This system includes:
at least one high-resolution sensor able to capture image data forming a digital image in a spectral band including at least all or some of the spectral band corresponding to the electromagnetic signals visible by the human eye, with a first spatial resolution, and an angular capture resolution strictly finer than the angular resolution of the human eye, and
a nonlinear processing module suitable for performing a change in spatial resolution while preserving bright points of said captured digital image to obtain a digital image to be displayed with a second spatial resolution lower than the first spatial resolution.

Advantageously, the system according to the invention is an EVS system using at least one sensor (of adjustable orientation or fixed) with a very fine angular resolution and significantly better than that of the eye in the visible spectral band, which makes it possible to:
have significantly improved range performance for detecting illuminated beacons relative to the eye,
be suitable for LED-type illuminated beacons,
be able to quantify its performance relative to the visual range of the human eye, independently of any variation in weather and atmospheric conditions.

Furthermore, the proposed system is less costly in terms of hardware and requires fewer calculation resources than a system based on sensors suitable for operating in several different spectral bands.

The system according to the invention may have one or more of the features below, considered independently or in all technically acceptable combinations.

Each digital image is defined by a matrix of pixels, each pixel having an associated value, said value being higher when a pixel is bright, and the nonlinear processing module is able to apply nonlinear filtering to a block of pixels of the captured digital image to determine a corresponding pixel value in the digital image to be displayed, said nonlinear filtering taking into account, for a block of pixels of the acquired digital image, at least the maximum value of said block of pixels.

The nonlinear filtering consists of associating a pixel of the digital image to be displayed with a value calculated from values above a predetermined threshold of the block of pixels corresponding to the captured digital image.

According to one alternative, the nonlinear filtering consists of associating a pixel of the digital image to be displayed with a value calculated from a given number of the highest values of the block of pixels.

The system comprises a plurality of juxtaposed high-resolution sensors.

The system comprises a high-definition sensor, suitable for being positioned in an image data capture position along a sighting axis, and members for moving said sensor, making it possible to move the siding angle of this sensor.

The high-resolution sensor capable of capturing digital image data is a first sensor in a first spectral band corresponding to the signals visible by the human eye, the signal further comprising a second sensor able to capture second digital image data in a second spectral band different from the first spectral band.

The second spectral band belongs to the domain of the infrared electromagnetic waves, with a wavelength comprised between 3 and 14 micrometers.

The system further comprises an image processing module suitable for merging said digital image to be displayed and the second digital image data captured by the second sensor.

The angular capture resolution is strictly finer than the angular resolution of the human eye, by a factor greater than or equal to 3.

According to a second aspect, the invention proposes a method suitable for providing an operator with enhanced visibility, intended to aid the piloting of an aircraft, carried out by a system comprising at least one sensor able to capture image data in a given spectral band and a central calculation unit able to process the captured image data and to transmit the processed image data for display of a digital image on a display unit. The method comprises the following steps:
capturing image data forming a digital image in a spectral band including at least all or some of the spectral band corresponding to the electromagnetic signals visible by the human eye, with a first spatial resolution, and an angular capture resolution strictly finer than the angular resolution of the human eye, and
applying a nonlinear processing module suitable for performing a change in spatial resolution while preserving bright points of said captured digital image to obtain a digital image to be displayed with a second spatial resolution lower than the first spatial resolution.

The advantages of the method being similar to the advantages of the system briefly described above, they are not recalled here.

The method according to the invention may have one or more of the features below, considered independently or in all technically acceptable combinations.

Each digital image is defined by a matrix of pixels, each pixel having an associated value, said value being higher when a pixel is bright, and the nonlinear processing module comprises the application of a nonlinear filtering to a block of pixels of the captured digital image to determine a corresponding pixel value in the digital image to be displayed, said nonlinear filtering taking into account at least the maximum value of said block of pixels.

The nonlinear filtering consists of associating a pixel of the digital image to be displayed with a value calculated from values above a predetermined threshold of the block of pixels corresponding to the captured digital image.

According to one alternative, the value associated with the pixel of the digital image to be displayed is calculated from a given number of the highest values of the block of pixels.

The method comprises another step for capturing second digital image data in a second spectral band different from the first spectral band.

The method comprises a step for merging the digital image with the second resolution obtained by nonlinear processing and the second digital image data.

Other features and advantages of the invention will emerge from the description thereof provided below, for information and non-limitingly, in reference to the appended figures, in which:

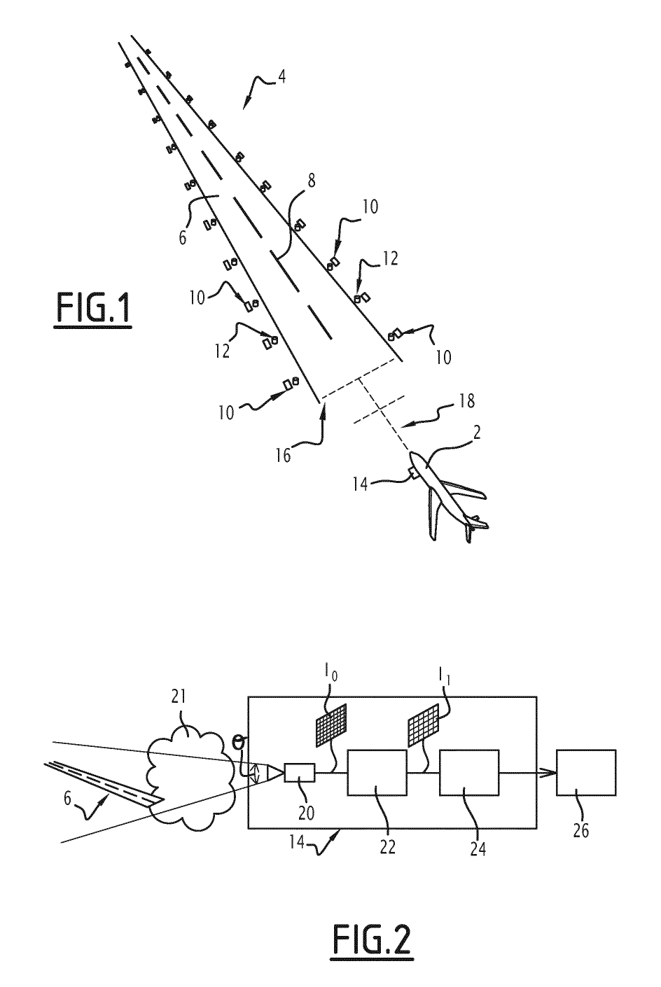

FIG. 1 schematically shows an aircraft approaching a runway marked by illuminated beacons;

FIG. 2 schematically illustrates an enhanced vision system according to a first embodiment;

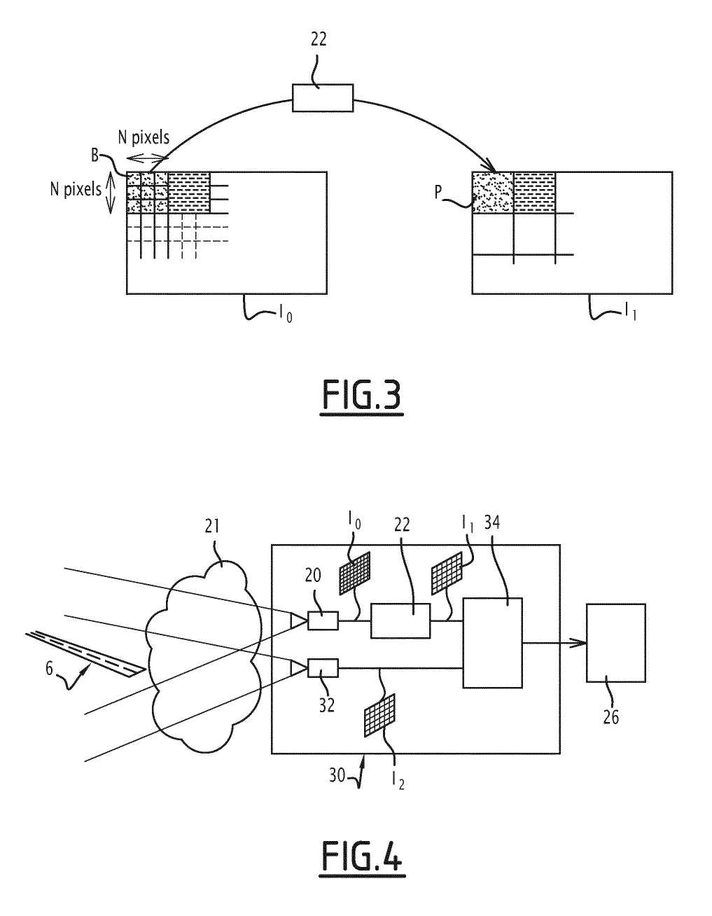

FIG. 3 schematically illustrates two images with different spatial resolutions;

FIG. 4 schematically illustrates an enhanced vision system according to a second embodiment.

The invention will be described as it applies to aiding the piloting of an aircraft, with the understanding that it is not limited to this application.

Indeed, the invention is more generally applicable in any context in which enhanced vision relative to the human vision of an operator is useful, for example for piloting other types of vehicles.

FIG. 1 schematically illustrates an application context of the invention, which is the landing of an aircraft.

In the example of FIG. 1, an aircraft 2 is on the landing approach on a landing field 4, comprising a landing strip 6.

The landing strip is marked by the various markers 8, 10, 12, 16, 18. For example, the markers 8 are runway center markers, the markers 10, 12 are runway edge illuminated beacons, positioned regularly over its entire length, the markers 16 are runway threshold markers and the markers 18 are approach ramp beacons.

The markers 8, 10, 12, 16, 18 emit at least in the spectral band visible to the operator's eye, and some may be made of light-emitting diode (LED) bulbs and others of incandescent bulbs.

Advantageously, the aircraft 2 is equipped with a system 14 suitable for providing the piloting operator with enhanced vision.

It should be noted that the system 14 is shown schematically in FIG. 1, and that in practice it is made up of several elements that are positioned in different locations or grouped together, as explained in more detail below.

According to a first embodiment illustrated schematically in FIG. 2, a system 14 according to the invention comprises an image sensor 20 in the spectral band of the electromagnetic rays or signals visible by the human eye, with a wavelength comprised between 0.4 μm to 0.7 μm, but in one alternative able to reach up to 1 μm.

Alternatively, the image sensor 20 operates in a spectral band comprising only part of the spectral band of the electromagnetic signals visible by the human eye.

The sensor 20 is a high-resolution sensor, making it possible to obtain an angular viewing resolution level finer than the human eye.

The digital image acquired by the sensor 20 has an associated spatial resolution, the spatial resolution being defined as the number of image data or pixels per unit of length. Each pixel has an associated radiometry value, also called intensity value.

Preferably, the sensor 20 is such that the ratio K between the angular resolution of the human eye and the angular image capture resolution is greater than or equal to 3. The digital image captured by such a sensor is said to be over-resolved because it has a finer angular resolution than the angular resolution achievable by the human eye.

The sensor 20 makes it possible to capture, along a sighting axis, a field of vision with a maximum angle θ preferably from about 35° to 40°.

Preferably, the sensor 20 is a CMOS (Complementarity Metal-Oxide Semiconductor) sensor, made up of photodiodes, and the manufacturing cost of which is moderate.

Alternatively, the sensor 20 is a CCD (Charge-Coupled Device) sensor or uses any other sensor technology.

In one alternative embodiment, in order to capture image data corresponding to the field of vision with angle θ, the sensor 20 is replaced by a plurality of field of vision sensors with an angle smaller than θ, juxtaposed and suitable for capturing image data corresponding to adjacent fields of vision or having an overlapping portion.

In another alternative embodiment, the high-resolution sensor 20 has a field of vision with an angle smaller than the desired angle, therefore a more restricted field of vision, but the sensor 20 is made movable by the movement members, making it possible to rotate it so that it can cover a wide field of vision of about θ. For example, such movement members are formed by an articulated or stationary link associated with a motor. In this embodiment, the sensor 20 is adjustable.

In practice, in the case of use to aid with the piloting of an aircraft 2, the sensor 20 is for example placed in front of the fuselage of the aircraft.

Advantageously, as explained in detail below, capturing an over-resolved image makes it possible to improve the visibility of the illuminated beacons with a quantifiable performance, including under reduced visibility conditions.

For example, a weather condition such as fog reducing the visibility is schematically illustrated by a cloud 21 in FIG. 2.

At the output of the sensor 20, an over-resolved digital image I₀ with a first spatial resolution R₀ is obtained, the image being made up of K*L pixels, for example 5120*4096. The digital image is defined by a matrix of values of pixels.

The data of the over-resolved digital image I₀, with a first spatial resolution R₀, are sent to a nonlinear processing module 22, for example via a data bus connected to the output of the sensor 20. The nonlinear processing module 22 is implemented by a programmable device, not shown, for example an onboard computer, comprising one or several processors able to perform calculations and execute computer instructions when they are powered on.

Alternatively, the programmable device implementing the nonlinear processing module 22, as well as any other calculation module, is implemented by an integrated circuit of the FPGA type or by a dedicated integrated circuit of the ASIC type.

The processing done by the nonlinear processing module 22 makes it possible to go from the first image I₀ with a first spatial resolution R₀ to a digital image I₁ with a second spatial resolution R₁, lower than the first spatial resolution R₀, while preserving contrast points of the image, in particular bright points (or positive contrast points) of the image.

Contrast points refer to points or pixels with an associated value significantly higher or significantly lower than the mean value of the pixels in the vicinity, for example 3 times greater than the standard deviation of the pixels in this vicinity.

The points with an associated value that is significantly greater than the surrounding values are bright points, and the contrast is said to be positive.

The points with an associated value that is significantly less than the surrounding values are dark points, and the contrast is said to be negative.

It should be noted that with a traditional resolution sensor, not over-resolved, it is possible to miss high-contrast points (positive or negative) due to the resolution of the sensor.

The processing done by the nonlinear processing module 22 makes it possible to keep positive contrast points in the digital image with the second spatial resolution lower than the first resolution.

FIG. 3 illustrates two such images I₀ and I₁, with a resolution factor equal to 3 between the first resolution R₀ and the second resolution R₁. Thus, a block B of 3×3 pixels of the digital image I₀ corresponds to a pixel P of the image I₁. The correspondence is a spatial correspondence in the respective matrices, as illustrated in FIG. 3.

More generally, a block B of M×N pixels of the image I₀ corresponds to a pixel of the image I₁.

In the preferred embodiment, the nonlinear processing applied by the module 22 to go from a block B, containing pixels (B_{i,j}), {i=3×i₁+k, j=3×j₁+k,k∈{0,1,2}} from the image I₀ to the pixel P_{i1,j1} of the image I₁ consists of associating the maximum value of the pixels from the block M×N of the image I₀ with the pixel P_{i1,j1}:

Pᵢ_{₁}_{,j}_{₁}=max(B_{i,j})

Thus, advantageously, the gain provided by the over-resolution of the image I₀ captured by the sensor 20 is preserved. The maximum intensity emitted by the illuminated beacons, captured by the over-resolved image capture, is kept in the digital image I₁ with the second resolution R₁.

Advantageously, the nonlinear processing module is suitable for keeping the illuminated points detected, in other words, preserving the brightest points of the block, since indeed, the brighter a point is, the higher the associated value in the digital image is.

The nonlinear processing applied preserves the bright points, but does not preserve the dark points, since only the brightest points are of interest for the targeted application to piloting aid.

Alternatively, the nonlinear processing module 22 applies other nonlinear processing operations of the filtering type preserving the maximum values or processing the pixels based on their rank. Filtering on overlapping windows can also be considered.

For example, for a given block, the values of the pixels of the block are kept that are above a threshold S. The threshold S can be set or calculated dynamically, as for example being the mean increased by 2 or 3 times the standard deviation of the values of the pixels of the block. All of the retained values, which are the values of the brightest pixels of the block according to the chosen criterion, are next used to obtain the final value of the pixel of the digital image I₁ with the second resolution R₁. For example, a mean of the retained values, therefore greater than the threshold S, of the considered block is calculated and attributed as final value of the corresponding pixel in the digital image I₁ with the second resolution R₁.

In another example, the values of the pixels of the considered block are sequenced in decreasing order of value, and the 2 (or 3) most significant values are kept. The retained values, which are the values of the brightest pixels of the block according to the chosen criterion, are next used to obtain the final value of the pixel of the digital image I₁ with the second resolution R₁. For example, a mean of the retained values of the considered block is calculated and attributed as final value of the corresponding pixel in the digital image I₁ with the second resolution.

At the output of the nonlinear processing module 22, the digital image with the second spatial resolution R₁ lower than the resolution R₀ is sent to an image processing module 24, able to apply traditional processing operations, for example for radiometry correction, geometric alignment for the display of the image I₁ on a display unit 26, for example a screen.

In one embodiment, the processing modules 22 and 24 are applied by a same onboard computer.

In one embodiment, the display is done by inlay on a display screen 26, located at the height of a piloting operators gaze, called head-up display.

The second resolution R₁ is preferably chosen as a function of the display resolution of the display screen 26, for example a head-up display. Alternatively, a “head-down” viewing screen, for example located on the dashboard, is used.

Advantageously, such a head-up display makes it possible to show the operator an enhanced view of the reality he may naturally perceive, and therefore aid him in piloting operations.

Thus, a viewing method suitable for providing an operator with enhanced vision according to the invention comprises a first step for acquiring a first digital image with a first spatial resolution using a high-resolution sensor able to capture image data in a spectral band corresponding to the signals visible by the human eye, with an angular capture resolution level strictly greater than the angular resolution of the human eye.

This first step is followed by a nonlinear processing step making it possible to obtain a second image with a second spatial resolution R₂, lower than the first spatial resolution and a second angular resolution adapted to the resolution of the display device.

Preferably, the factor between the angular capture resolution and the angular resolution of the human eye is greater than or equal to 3, i.e., the angular capture resolution is at least 3 times finer than the angular resolution of the human eye.

Advantageously, the performance of the proposed system is able to be calculated, independently of the weather conditions.

Indeed, a weather condition is characterized by an absorption coefficient σ in a given spectral band.

According to the Beer-Lambert-Bouguer law, the intensity evolves as a function of the distance X and the absorption coefficient σ as follows:

$$l ( X ) = {l}_{0} \cdot exp ( - σ ( X - {X}_{0} ) ) \cdot {( \frac{{X}_{0}}{X} )}^{2}$$

Where X₀ is a reference distance with which the intensity I₀ of an illuminated beacon is associated.

By accounting for a variation in the angular resolution, where α is the angular resolution of the pixel for EVS equipment using the method according to the invention and α_{ref} is the angular resolution of the pixel for reference EVS equipment using an angular resolution equivalent to the display resolution, one obtains:

$$l ( X ) = {l}_{0} \cdot exp ( - σ ( X - {X}_{0} ) ) \cdot {( \frac{{X}_{0}}{X} )}^{2} \cdot {( \frac{{α}_{ref}}{α} )}^{2}$$

Under weather conditions leading to an extinction coefficient of 0.01 m⁻¹, one for example obtains:
a same signal-to-noise ratio for illuminated beacons at 500 m with a reference sensor with angular resolution α_{ref} and at 1000 m with a sensor with an angular resolution refined by a factor of 25 (α=α_{ref}/25), i.e., a resolution level greater by a factor of 25 leads to a range gain by a factor of 2,
a same signal-to-noise ratio for illuminated beacons at 800 m with a reference sensor with angular resolution α_{ref} and at 1000 m with a sensor with an angular resolution refined by a factor comprised between 3 and 4 (α=α_{ref}/3.5), i.e., a resolution level greater by a factor of 3.5 leads to a range gain of 25%.

Consequently, it is demonstrated that a higher-level angular resolution allows a quantifiable decrease in the detection range brought by the EVS equipment.

In one alternative of this first embodiment, the system according to the invention is an EVS system using at least one sensor (of adjustable orientation or fixed) with a very fine angular resolution in a spectral band different from that of the eye, which makes it possible to have detection range performance levels of the illuminated beacons that are significantly improved relative to an EVS system having a resolution in the class of that of the eye in this same spectral band.

A second embodiment of a system 30 suitable for providing enhanced vision according to the invention is shown in FIG. 4.

The system 30 comprises, aside from the first sensor 20 able to acquire images with a very high spatial resolution in the visible spectral band, and the processing unit 22 previously described, constituting a first imaging channel, a second sensor 32 able to capture images I₂ in a spectral band other than the visible spectral band, preferably the infrared spectral band.

Preferably, the spatial resolution of the images I₂ captured by the sensor 32 is substantially equal to the second spatial resolution R₂ of the images obtained at the output of the nonlinear processing module 22.

The capture by this second sensor 32 forms a second imaging channel.

The system 30 also comprises a processing module 34 suitable for merging the images I₁ and I₂, corresponding to a same field of vision, in particular by applying, with techniques known in the image processing field, a radiometry check on each of the channels, a geometric alignment making it possible to make the images I₁ and I₂ superimposable and a pixel to pixel addition.

The processing module 34 is also suitable for performing any image correction for the display.

In practice, the processing module 34 is implemented by a programmable device, not shown, for example an onboard computer, comprising one or several processors able to perform calculations and execute computer instructions when they are powered on.

The processing module 34 carries out a step for merging the digital image with the second resolution I₁ obtained by nonlinear processing done during the nonlinear processing step by the module 22, and the second digital image data I₂ captured by the sensor 32.

The resulting merged image is next transmitted to a display unit 26, similar to the display unit 26 described above in reference to FIG. 2, for example a screen, for inlay and display.

Advantageously, the proposed system allows a capture of an image with a first spatial resolution that is over-resolved, which makes it possible to capture positive contrast points, i.e., bright points relative to their vicinity, and to preserve these positive contrast points in the digital image with a second spatial resolution, lower than the first resolution. Ultimately, a digital image with a second spatial resolution for display and exploitation is obtained, but this image comprises brightness information that would not have been able to be captured with an image acquisition at said second spatial resolution.

1. A system suitable for providing an operator with enhanced visibility, intended to aid the piloting of an aircraft, comprising at least one sensor able to capture image data in a given spectral band and a central calculation unit able to process the captured image data and to transmit the processed image data for display of a digital image on a display unit,
comprising:
at least one high-resolution sensor able to capture image data forming a digital image in a spectral band including at least all or some of the spectral band corresponding to the electromagnetic signals visible by the human eye, with a first spatial resolution, and an angular capture resolution level strictly finer than the angular resolution of the human eye, and
a nonlinear processing module suitable for performing a change in spatial resolution while preserving bright points of said captured digital image to obtain a digital image to be displayed with a second spatial resolution lower than the first spatial resolution.

2. The system according to claim 1, wherein each digital image is defined by a matrix of pixels, each pixel having an associated value, said value being higher when a pixel is bright, the nonlinear processing module being able to apply nonlinear filtering to a block of pixels of the captured digital image to determine a corresponding pixel value in the digital image to be displayed, said nonlinear filtering preserving the bright points and taking into account, for a block of pixels of the acquired digital image, at least the maximum value of said block of pixels.

3. The system according to claim 2, wherein the nonlinear filtering preserving the bright points consists of associating a pixel of the digital image to be displayed with a value calculated from values above a predetermined threshold of the block of pixels corresponding to the captured digital image.

4. The system according to claim 2, wherein the nonlinear filtering preserving the bright points consists of associating a pixel of the digital image to be displayed with a value calculated from a given number of the highest values of the block of pixels corresponding to the captured digital image.

5. The system according to claim 1, comprising a plurality of juxtaposed high-resolution sensors.

6. The system according to claim 1, further comprising a high-definition sensor, suitable for being positioned in an image data capture position along a sighting axis, and members for moving said sensor, making it possible to move the siding angle of this sensor.

7. The system according to claim 1, wherein said high-resolution sensor capable of capturing digital image data is a first sensor in a first spectral band corresponding to the signals visible by the human eye, further comprising a second sensor able to capture second digital image data in a second spectral band different from the first spectral band.

8. The system according to claim 7, wherein the second spectral band belongs to the domain of the infrared electromagnetic waves, with a wavelength comprised between 3 and 14 micrometers.

9. The system according to claim 7, it further comprising an image processing module suitable for merging said digital image to be displayed and the second digital image data captured by the second sensor.

10. The system according to claim 1, wherein the angular capture resolution is strictly finer than the angular resolution of the human eye, by a factor greater than or equal to 3.

11. A method suitable for providing an operator with enhanced visibility, intended to aid the piloting of an aircraft, carried out by a system comprising at least one sensor able to capture image data in a given spectral band and a central calculation unit able to process the captured image data and to transmit the processed image data for display of a digital image on a display unit,
comprising:
capturing image data forming a digital image in a spectral band including at least all or some of the spectral band corresponding to the electromagnetic signals visible by the human eye, with a first spatial resolution, and an angular capture resolution strictly finer than the angular resolution of the human eye, and
applying a nonlinear processing suitable for performing a change in spatial resolution while preserving bright points of said captured digital image to obtain a digital image to be displayed with a second spatial resolution lower than the first spatial resolution.

12. The method according to claim 11, wherein each digital image is defined by a matrix of pixels, each pixel having an associated value, said value being higher when a pixel is bright, the wherein at the nonlinear processing comprises the application of a nonlinear filtering to a block of pixels of the captured digital image to determine a corresponding pixel value in the digital image to be displayed, said nonlinear filtering taking into account at least the maximum value of said block of pixels.

13. The method according to claim 12, wherein the nonlinear filtering consists of associating a pixel of the digital image to be displayed with a value calculated from values above a predetermined threshold of the block of pixels corresponding to the captured digital image.

14. The method according to claim 12, wherein the nonlinear filtering consists of associating a pixel of the digital image to be displayed with a value calculated from a given number of the highest values of the block of pixels corresponding to the captured digital image.

15. The method according to claim 11, it further comprising another step for capturing second digital image data in a second spectral band different from the first spectral band.

16. The method according to claim 15, further comprising a step for merging the digital image with the second resolution obtained by nonlinear processing and the second digital image data.
